(19) United States
(12) Patent Application Publication
(10) Pub. No.: US 2022/0240702 A1
(43) Pub. Date: Aug. 4, 2022

(54) APPARATUSES AND SYSTEMS FOR IMPROVING VISIBILITY OF A MAT

(71) Applicant: Nanette Barrientos Vince-Cruz, Indianapolis, IN (US)

(72) Inventor: Nanette Barrientos Vince-Cruz, Indianapolis, IN (US)

(21) Appl. No.: 17/444,710

(22) Filed: Aug. 9, 2021

Related U.S. Application Data
(60) Provisional application No. 63/199,863, filed on Jan. 29, 2021.

(51) Int. Cl. A47G 27/02; F21V 33/00; H05B 47/13

(52) U.S. Cl. CPC A47G 27/0231; F21V 33/0004; A47G 2200/04; A47G 2200/085; H05B 47/13

(57) ABSTRACT

Apparatuses and systems for providing improved visibility for a user in a space is disclosed. As part of the systems disclosed herein, a mat is provided that is designed to support the user. A plurality of lights and one or more sensors are operatively connected to the mat. A controller is operatively associated with the mat, sensor(s) and lights so that it can selectively activate the lights based on a signal received from the sensor(s), the signal indicating the presence of the user proximal the mat.

### CROSS-REFERENCE TO RELATED APPLICATION

This application claims the benefit of priority of U.S. provisional application No. 63/199,863, filed Jan. 29, 2021, the contents of which are herein incorporated by reference.

### BACKGROUND OF THE INVENTION

The present invention relates to mats and, more particularly, to various apparatuses and systems, described herein, that improve visibility of a mat.

Though mats lessen fatigue for users when standing for prolonged periods, they may be trip/fall hazards to individuals, especially those with higher risk to those with visual impairments. Individuals that are visually impaired over the world number approximately 2.2 billion, according to the World Health Organization statistics on Oct. 8, 2020. Visual impairment interferes with the ability to perform everyday activities, such as orientational ability and functional mobility, increases level of dependence from other people, and impacts quality of life. Even individuals who may have normal visual acuity (i.e., 20/20 vision) may have difficulty with visual perception. Some people may require three times the amount of light to see in an environment or to see from further distances due to conditions in the eye or brain.

Mats available in the market have no lighting systems and/or automation systems, which result in a trip/fall hazard to individuals with normal vision and those who may have such described vision impairments. Many daily activities require functional mobility and standing for a prolonged periods and the use of a mat helps ease the fatigue of the individual.

However, placing a mat, without a lighting system/automation, on the floor to ease fatigue that onsets from prolonged standing to perform daily activities increases trip/fall/injury risk of individuals with and without a visual impairment. Individuals who have a visual impairment may have difficulty with visual acuity, with identification of a mat and safety risks in its surrounding area, with perceiving the three dimensions and distance of the mat affecting accuracy of mobility, with visual information processing and speed, with eye/brain function to adapt, with reduced visibility area. Even individuals who may have 20/20 vision or within the normal limits of visual acuity may have difficulty with visual perception with reduced visibility.

Individuals with visual impairments can become isolated from other people more easily, which further increases limitation on daily activities and physical mobility and increases level of dependence with other people which can negatively impact quality of life. As can be seen, there is a need for a vision aid mat as described herein.

### SUMMARY OF THE INVENTION

In one aspect of the present invention, a system for providing improved visibility for a user in a space is disclosed, the system comprising: a mat configured to support the user; one or more sensors operably coupled to the mat; a plurality of lights operatively coupled to the mat and configured to illuminate at least a portion of the mat; and a controller operably associated with the mat, the one or more sensors, and with the plurality of light, the controller being configured to selectively activate the plurality of lights based on a signal received from the one or more sensors.

These and other features, aspects and advantages of the present invention will become better understood with reference to the following drawings, description and claims.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is a top perspective view of an embodiment of the present invention;

FIG. 2 is a bottom perspective view of the embodiment of the present invention; and

FIG. 3 is a schematic view of the embodiment of the present invention.

### DETAILED DESCRIPTION OF THE INVENTION

The subject disclosure is described with reference to the drawings, wherein like reference numerals are used to refer to like elements throughout. In the following description, for purposes of explanation, numerous specific details are set forth in order to provide a thorough understanding of the present disclosure such that one skilled in the art will be enabled to make and use the present invention. It may be evident, however, that the present disclosure may be practiced without some of these specific details.

Broadly, an embodiment of the present invention is a system for providing improved visibility for a user in a space. As part of the embodiment, a mat is provided that is designed to support the user. A plurality of lights and one or more sensors are operatively coupled to the mat. A controller is operatively associated with the mat, sensor(s) and lights such that it selectively activates the lights based on a signal received from the sensor(s), with the signal indicating the presence of the user proximal the mat in the space.

The present invention provides a visual sensory system that transforms light into a psychological experience of the world around a individual. In certain embodiments, a vision aid mat is provided with a lighting system that may compensate for limitations from visual deficits or that may address the effect of visual impairment on an individual's productivity and quality of life. The present invention advantageously improves the visibility of an anti-fatigue mat by better identifying the mat and surrounding area. In doing so, the individual's safety, level of independence with daily activities, quality of life and general well-being are maximized. It may further minimize slip/trip/fall/injury risk of people when standing properly on the mat.

There are no similar solutions to the present invention described herein. Mats produced in accordance with the teachings of the present invention include a unique lighting system with contrasting colors that provide a visual aid to people with visual impairment or otherwise poor vision. The lighting system (1) identifies the mat from surrounding area during reduced visibility, (2) may improve an individual's visual acuity, depth perception and/or visual perception, (3) may assist the individual's orientation ability and functional mobility, and (4) may add for aesthetics (based on the theme) of the mat. Light is an important factor in the transformation of visual sensory information to neural energy for people to perform their daily activities safely by minimizing trip/slip/fall/injury risk.

The vision aid mat may include a soft density core that helps to reduce stress and shock absorption (i.e., cushioning) on the feet, ankle joints, knee joints, hip joints, and back/vertebrae. When standing on the cushioned mat, the individual's well-aligned body decreases fatigue by utilization of large muscle groups (recovers faster from metabolic factors such as oxygen and blood flow) and by even distribution of the individual's body weight on the joints in static/dynamic standing for extended periods with house chores in various locations about the home, such as the kitchen, a sink, while doing laundry, in the driveway, in the garage, at an island table, at a craft table, or at a counter. Further, embodiments of the present invention may be used in office/occupational work at a standing desk/workshop, for example.

Further, the vision aid mat's thickness (i.e., height) adds to the firmness of the floor, which may maintain an individual's standing balance and normal body alignment that decreases risk of strain/injury to the muscles/ligaments/soft tissues of the body when standing for a prolonged period. The vision aid mat may be further provided with anti-skid rubber bottom surface which increases the friction against the contacting surfaces of the floor, thus maximizing safety and minimizing trip/slip/fall/injury risk of people when standing properly on the mat. Automation of the vision aid mat via motion controlled light sensors, smart devices, or smart assistants even further maximizes safety by providing more time for eye/brain function and is described in greater detail below.

The vision aid mat of the present invention has a lighting system and motion sensor system for illumination of the mat in the area which (1) improves visual acuity and perception of the mat and its surrounding area by allowing for identification of the vision aid mat during reduced visibility, (2) improves contrast of the vision aid mat with a surrounding area of the mat, creating a better three-dimensional and distance perception, and (3) assists in orientation and mobility which may increase level of independence with respect to daily activities, safety, improve quality of life, and general well-being.

All elements, unless otherwise noted, are important aspects of the present invention. Data from usage history is an element that may be added to assist the user in light and time configuration from the patterns of an individual's habits to automatically set the lighting system and maximize power efficiency. Elements that may also be added or modified are other types, positioning and placement such as, shades, modes, transparency/opacity, and aesthetic designs of lighting system to maximize the three-dimensional effect or assist with the identification of the mat from a distance when approaching the mat. Other types of sensor systems may be utilized as well such as: human sensing such as occupancy sensor(s), proximity sensor(s), acoustic sensor(s), image recognition of human shapes, infrared detectors, pressure sensitive floor tiles positioned proximate the floor mat, WiFi™ sensing (i.e., a sensor that uses radio signals between nearby devices to sense), and/or other sensors to still be developed. These are all elements that may be added or implemented by reconfiguration of the mat to sense a more accurate data of human factor analysis to distinguish from pets or other figures/motion to maximize energy efficiency and/or may improve the usage history data.

Further, integration of the mat with smart devices/assistants is preferred, but optional. Adding this optional feature will make the vision aid mat work better by automation of a preferred preset lighting system schedule that may be set in a user's smartphone and/or easy access by voice command. Automation of the mat's lighting system provides an increased time factor to identify the mat/surrounding area prior to approaching the mat, increases compensatory input in the visual system, helps eye and brain function to adjust to further distinguish depth of the mat, and reduces the safety risk of individuals and of those who are visually impaired.

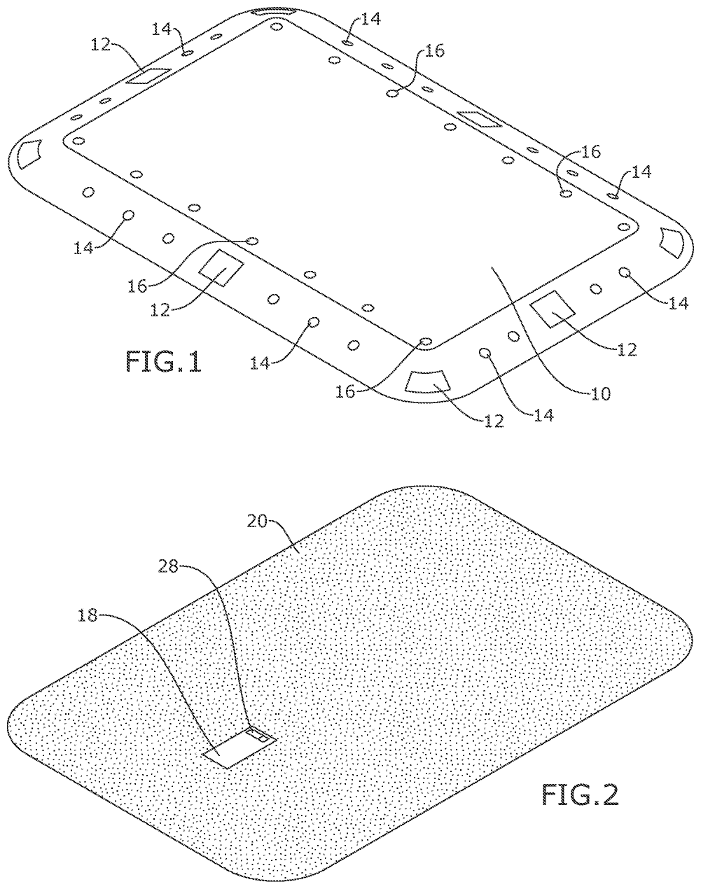

Referring now to FIGS. 1-3, generally, a cushioned anti-fatigue mat 10 in accordance with the present invention is integrated with one or more sensors 12 (e.g., motion sensor), a plurality of lights 14, 16, wiring 26 (or other appropriate means of facilitating electrical coupling), and a power source 24 (which may be embodied as a battery). The components may be encapsulated, embedded, clamped, or otherwise coupled to the mat 10. In certain embodiments, the mat may be formed from a polyvinyl chloride (PVC) material of various sizes to accommodate the demand. However, those skill in the art will appreciate that other soft density materials may be used in accordance with the present invention. A non-skid surface 20 may be embodied as a rubber material attached to a bottom surface of the mat 10. This surface 20 serves increase friction with the floor when the mat 10 is placed thereon.

The plurality of lights 14, 16 may be embodied in contrasting colors, such a first color light 14 and a second color light 16. In certain embodiments, the lights 14, 16 may be a single color provided in separate modes (e.g., static and dynamic). In certain embodiments, the first lights 14 may be provided as static lights, and the second lights 16 may be provided as dynamic/pulsating lights (with one or more modes that may be set). As shown, the lights 14, 16 may be at least partially encapsulated in and disposed along the periphery of the mat 10, on the corners, and/or on the top surface on the mat 10. In other embodiments, the lights 14, 16 may be projected onto the mat 10. These various described methods of incorporating the lights 14, 16 with the mat 10 (e.g., direct physical connection or a non-physical, operative connection) constitute an operable coupling of the lights 14, 16 and mat 10. The total number of lights 14, 16 may be varied based upon the size of the mat 10, and more than two may be utilized in accordance with the present invention. Further, the lights 14, 16 may be embodied as individual or strips of lights, and may be provided in housings that are transparent, low opacity, or high opacity, depending upon various design consideration.

As shown, sensors 12 (such as motion sensors) may be provided about a periphery of the mat 10 and may at least partially encapsulated therein. These sensors 12 are operable to activate some or all the lights 14, 16. When embodied as motion sensors 12, they may be encapsulated in the mat 10 or potentially placed remotely within the detected range of the mat 10 such that they are capable of sending a signal to the mat 10 to activate the lights 14, 16. The sensors 12 may be embodied as a motion and occupancy sensor system (with the number of motion sensors being based according to the size of the mat) to activate of some or all of the lights 14, 16 on the mat 10. They may be embodied as electronic motion detectors such as passive infrared (PIR) sensors, occupancy sensors, proximity sensors, acoustic sensors, image recognition of human shapes, infrared detectors, pressure sensitive floor tiles, and/or WiFi™ sensing. Any sensor type may be used in accordance with the present invention. Further, a pressure contact system may be placed on the top, on the bottom surface, or in the mat 10 and may assist in light configuration/automation. These various above-described methods of incorporating the lights 12 with the mat 10 (e.g., direct physical connection or a non-physical, operative connection) constitute an operable coupling of the sensors 12 and mat 10.

The battery 24 is housed in a battery/electronics compartment 18, with a switch 28 being disposed on an exterior of the compartment 18 for a user 30 to selectively turn on and off the mat 10. The battery 24 powers the lighting, the motion sensor(s) 12, and other components that provide functionality to the mat 10. For example, an example of such components is a controller, such as a central processing unit 22 (CPU) which is operably associated with the rest of the system of the present invention and controls the lights 14, 16 based on input obtained from the sensors 12, and may be further operable to integrate with other systems, like smart assistants or other smart devices. In certain embodiments, the processor 22 may be provided on a printed circuit board (PCB). Further, the battery 24 may be embodied in various forms, such as disposable and rechargeable (via, for example, USB charging), and may be contained within a separate box within the compartment 18. When utilizing USB charging, a USB port may be provided on an outer surface of the mat 10, with a flap being provided to selectively expose the port. The USB port may be utilized for other purposes, such as data transfer from the mat 10. The compartment 18 may also be configured to house other components, such as, but not limited to, memory for storing mat data and the processor 22.

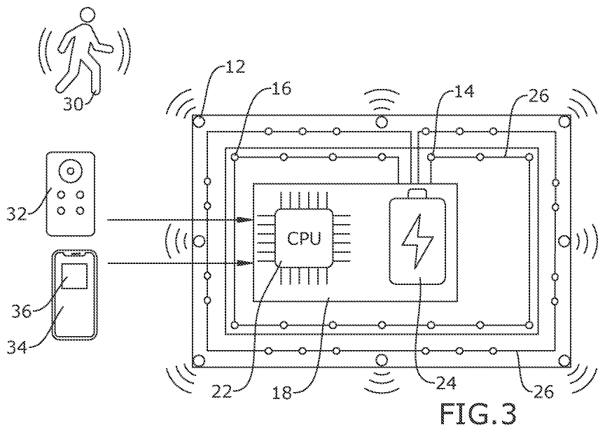

The insulated wiring 26 connects the lights 14, 16, sensors 12, the power source/battery 24, and other electronics components. As shown in FIG. 3, the mat 10 may be controlled via a remote 32, an application 36 loaded on a smart device 34, or via the voice of a user 30 that communicates with a smart assistant paired with the mat 10. The smart device 34 of the present invention may include at least one computer with a user interface. The computer may include at least one processing unit coupled to a form of memory. The smart device may include, but is not limited to, a desktop, laptop, tablet, smart phone, and home assistant. The computer includes a program product including a machine-readable program code for causing, when executed, the computer to perform steps. The program product may include systemic software which may either be loaded onto the computer or accessed by the computer. The loaded systemic software may include an application on a smart device. The systemic software may be accessed by the computer using a web browser. The computer may access the systemic software via the web browser using the internet, extranet, intranet, host server, internet cloud and the like.

In use, the vision aid mat is placed on the floor. The whole or part of the lighting system may be activated via the main switch 28, sensor(s) 12, remote 32, smart devices 34, smart assistant via voice activation by a user 30, and/or other automation systems described herein. As described above, the lighting system may be implemented in various ways, such as including one or more contrasting colors 14, 16 with static and/or pulsating modes for identification of the mat, and/or individual or strips of light to illuminate the surrounding area during reduced visibility (or in normal lighting conditions). This improves visual acuity and perception, and in particular, increases orientation ability and functional mobility of individuals who may have visual impairments. Upon activation of the lighting system 14, 16, a user 30 approaches and walks on the vision aid mat 10 with appropriate footwear and/or devices. The cushioned mat 10 may assist with minimizing shock absorption on joints, with maintaining normal body alignment, and with minimizing muscle and soft tissue strain/fatigue. The lighting system 14, 16 may be turned off manually (via a switch, remote, or application) and/or automatically when sensors 12 do not detect the user 30, or at programmed times/non-movement detection of the user 30. The lights 14, 16 may also turn off (i.e., activate) via activation of pressure contact sensors upon stepping onto the mat 10. When needed, the power source 24 (such as batteries) may be replaced or recharged.

The lighting system 14, 16 of the vision aid mat refers to any form or size of light such as, but not limited to: light bulbs, LED lights, and/or newer technology lights which can be encapsulated in and/or otherwise attached to or be operatively associated with the mat 10. If the lights 14, 16 cannot be encapsulated in and/or attached to the mat 10, they may be incorporated in other ways such as, but not limited to projected light to the mat 10, with these alternative embodiments of the present invention functioning as part of the vision aid mat 10. Further, while sensors are primarily described in the context of being motion sensors, a person of ordinary skill would appreciate that any appropriate sensor type may be used in accordance with the present invention (and as discussed above). The present invention, with its unique lighting system, can be applied to table mats, children's play mats, step/stair mat/rugs, chair/seat cushions, car seats, car floor mats, met mats/mattresses/cushions, gym mats, bath/shower/tub mats, and more. Further, those with skill in the art will appreciate that embodiments of the present invention may be used in healthcare facilities, in rooms of assisted living facilities, in nursing homes, in children's facilities, and more.

While methods of making the present invention would be readily apparent to those with skill in the art from the foregoing, a method of making the present invention may further include the following. The lighting system and motion sensor system are manufactured with the cushioned mat, electrical system, power source, and potentially with the optional feature of integration system of products and smart devices.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein.

While apparatuses and methods are described in terms of “comprising,” “containing,” or “including” various components or steps, the apparatuses and methods can also “consist essentially of” or “consist of” the various components and steps. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A system for providing improved visibility for a user in a space, the system comprising:
a mat configured to support the user;
one or more sensors operably coupled to the mat;
a plurality of lights operatively coupled to the mat and configured to illuminate at least a portion of the mat; and
a controller operably associated with the mat, the one or more sensors, and with the plurality of light, the controller being configured to selectively activate the plurality of lights based on a signal received from the one or more sensors.

2. The system of claim 1, wherein the one or more sensors, the plurality of lights, or the one or more sensors and the plurality of lights are physically coupled the mat.

3. The system of claim 2, wherein the one or more sensors, the plurality of lights, or the one or more sensors and the plurality of lights are embedded in the mat.

4. The system of claim 1, wherein the plurality of lights is disposed on one or more peripheral edges of the mat.

5. The system of claim 1, wherein the plurality of lights comprises a first light comprising a first color and a second light comprising a second color, the first and the second color being different from one another.

6. The system of claim 1, wherein the plurality of lights comprises a first light that is static, when activated, and a second light that pulsates, when activated.

7. The system of claim 1, wherein the plurality of lights is configured to deactivate manually or automatically.

8. The system of claim 1, wherein the one or more sensors is selected from the group consisting of: a passive infrared (PIR) sensor, an occupancy sensor, a proximity sensor, an acoustic sensor, an image recognition system, an infrared detector, a pressure sensitive floor tile, and a sensor that uses radio signals sent wirelessly between nearby devices.

9. The system of claim 1, wherein the mat comprises a soft density material.

10. The system of claim 1, further comprising a remote, an application loaded on a smart device, or a virtual assistant device operatively paired with the mat.
